(19) United States
(12) Patent Application Publication
(10) Pub. No.: US 2022/0299989 A1
(43) Pub. Date: Sep. 22, 2022

(54) METHODS FOR CONFIGURING AND OPERATING A THERMAL ENERGY STORAGE SYSTEM AND THERMAL ENERGY STORAGE SYSTEM

(71) Applicant: Siemens Gamesa Renewable Energy GmbH & Co. KG, Hamburg (DE)

(72) Inventors: Jan Rudolf Eggers, Bliedersdorf (DE); Niels Pagelsen, Hamburg (DE); Tom Westermann, Hamburg (DE); Sergey Yashchenko, Hamburg (DE); Alexander Zaczek, Hamburg (DE)

(21) Appl. No.: 17/640,688

(22) PCT Filed: Sep. 8, 2020
(86) PCT No.: PCT/EP2020/075061

§ 371 Date: Mar. 4, 2022

(30) Foreign Application Priority Data
Sep. 11, 2019 (EP) 19196619.1

(51) Int. Cl. G05B 23/02; G05B 13/04

(52) U.S. Cl. CPC G05B 23/0297; G05B 23/0254; G05B 13/042; G05B 13/048

(57) ABSTRACT

Provided is a method for configuring a thermal energy storage system including the following steps:

providing a thermal energy storage device for storing heat,

providing a plurality of temperature sensors at different locations of the thermal energy storage device for measuring temperatures at the different locations,

providing a control device of the thermal energy storage system for reading measurement data of the plurality of temperature sensors,

generating a numerical model for at least one first temperature sensor of the plurality of temperature sensors based on the measured temperatures of the plurality of temperature sensors means of machine learning, and

storing the numerical model by a control device, for configuring the thermal energy storage system,

Furthermore, a thermal energy storage system and a method for operating a thermal energy storage system is also provided.

### CROSS-REFERENCE TO RELATED APPLICATIONS

This application claims priority to PCT Application No. PCT/EP2020/075061, having a filing date of Sep. 8, 2020, which claims priority to EP Application No. 19196619.1, having a filing date of Sep. 11, 2019, the entire contents both of which are hereby incorporated by reference.

### FIELD OF TECHNOLOGY

The following is related to a method for configuring a thermal energy storage system, especially an electro thermal energy storage system. The following is further related to a thermal energy storage system, especially an electro thermal energy storage system, and to a method for operating a thermal energy storage system, especially an electro thermal energy storage system.

### BACKGROUND

Thermal energy storage systems are used for storing heat in a thermal energy storage device of the thermal energy storage system. Electro thermal energy storage systems are generally used for converting electrical power into heat and for storing the generated heat in a thermal energy storage device of the electro thermal energy storage system. The heat is usually stored for later use, especially in a steam generator of a power plant or the like. A heat transfer fluid, e.g. air, is used for the transportation of energy within the thermal energy storage system.

In order to operate the thermal energy storage system, especially the electro thermal energy storage system, efficiently, a mass flow of the heat transfer fluid as well as its temperature have to be controlled. The thermophysical parameters of the heat transfer fluid corresponds to an operation mode of the thermal energy storage system and, therefore, vary over time.

In general, thermal energy storage systems comprise a plurality of sensors, such as temperature sensors, pressure sensors or the like, to collect information about physical parameters, such as temperature, pressure or other properties of the thermal energy storage system. The state of charge (SOC) is one example of necessary control parameters for operating the thermal energy storage system that can be obtained from the measured physical parameters. The SOC corresponds with the amount of heat stored within the thermal energy storage system.

In the past, for obtaining a reliable information about a status of a thermal energy storage device, a plurality of sensors is arranged at the thermal energy storage device for measuring physical parameters, such as temperature, pressure or the like. The more sensors used, the higher are production costs of the thermal energy storage system. Moreover, in many cases, lifetime of a sensor is less than lifetime of the thermal energy storage device. This means that during lifetime of the thermal energy storage systems, sensors are very likely to fail.

Consequently, the broken sensors must be replaced. This requires dismounting the thermal energy storage system, dismounting the broken sensors, mounting the new sensors and mounting the thermal energy storage system. This procedure is expensive and time consuming. In case the broken sensors are not replaced, the thermal energy storage system can only be used partially based on the measured physical values by the remaining working sensors. This leads to a decrease of accuracy of analyzing the status of the thermal energy storage device, e.g. the SOC, and, therefore, to a limited performance of the thermal energy storage system.

### SUMMARY

Therefore, an aspect relates to provide a solution that does not show the limitations of the state in the art or at least is an improvement over the state in the art. An aspect especially relates to provide a method for configuring a thermal energy storage system, especially an electro thermal energy storage system, a thermal energy storage system, especially an electro thermal energy storage system, and a method for operating a thermal energy storage system, especially an electro thermal energy storage system, that promote less production costs and/or less maintenance costs and/or improved reliability of the thermal energy storage system.

According to a first aspect of embodiments of the invention, the problem is solved by a method for configuring a thermal energy storage system. The method comprising the following steps:
providing a thermal energy storage device for storing heat,
providing a plurality of temperature sensors at different locations of the thermal energy storage device for measuring temperatures at the different locations,
providing a control device of the thermal energy storage system for reading measurement data of the plurality of temperature sensors,
generating a numerical model for at least one first temperature sensor of the plurality of temperature sensors based on measured and/or simulated temperatures of the plurality of temperature sensors by means of machine learning, and
storing the numerical model by a control device of the thermal energy storage system, for configuring the thermal energy storage system.

For executing the method, a thermal energy storage system, especially an electro thermal energy storage system, with a thermal energy storage device for storing heat is needed. It is desired that an electro thermal energy storage system is provided that is capable of transforming electrical energy into heat. A thermal energy storage system is provided that operates with air as heat transfer fluid.

“Electro thermal energy storage system” is particularly to be understood that a thermal temperature increase of the working fluid is performed by a device—usually an electrical heater—that is operated with electrical energy.

Moreover, the plurality of temperature sensors is provided at the thermal energy storage device. The temperature sensors are configured to measure the temperatures of the thermal energy storage device, especially each at a specific location of the thermal energy storage system. Therefore, with temperature sensors, a state of charge of the thermal energy storage device can be reliably determined. For this purpose, the temperature sensors are provided at different locations within the thermal energy storage device. The temperature sensors are evenly distributed over the volume of the thermal energy storage device. Additional sensors, such as force sensors, pressure sensors, flow sensors, displacement sensors and humidity sensors are provided and used for generating the numerical model. Pressure sensors and flow sensors can be used to determine fluid mechanical properties of the heat transfer fluid, such as current speed or the like. The temperature sensors and/or the pressure sensors and/or flow sensors and/or displacement sensors and/or humidity sensors are evenly distributed over the volume of the thermal energy storage device. This has the advantage that a status of the electro thermal energy storage system can be determined reliably and in a cost efficient way.

A “temperature sensor” according to embodiments of the invention may directly measure temperatures. Alternatively, a sensor device can be used that measures a different physical entity or different physical entities but derive temperature information from this/these measured entity/entities, like a change of a voltage value at a resistor placed in the thermal energy storage system.

Beyond that, the control device of the thermal energy storage system for reading measurement data of the plurality of temperature sensors and the other sensors is provided. The control device is configured for evaluating the measurement data provided by the sensors, in order to evaluate the status of the thermal energy storage system, especially the state of charge (SOC) or the like. A control device is provided that comprises a data storage device for storing the numerical model. The control device is configured for operating the thermal energy storage system, especially by using the numerical model.

Furthermore, the numerical model for the at least one first temperature sensor of the plurality of temperature sensors is generated. The numerical model is generated based on the measured physical parameters of the plurality of temperature sensors by means of machine learning. In this regard, the measurement data of the whole plurality of temperature sensors or at least of a group of the plurality of temperature sensors is used. The numerical model is generated by means of supervised machine learning, especially “regression type” supervised machine learning. It is further desired that the numerical model is also based on the other sensors, such as pressure sensors.

With the numerical model, a measurement value of the at least one first temperature sensor can be simulated on the basis of evaluation of measurement values of the remaining temperature sensors of the plurality of temperature sensors or at least of a group of the remaining temperature sensors. With other words, with the numerical model, the at least one first temperature sensor is replaceable by at least one virtual first temperature sensor. The numerical model is configured for providing substitutional virtual temperature sensors for a group of temperature sensors of the plurality of temperature sensors or, desirably, for the whole plurality of temperature sensors. Alternatively, or in addition, the numerical model can be generated based on computational fluid dynamics (CFD), finite element method (FEM) and/or discrete element method (DEM) data. Thus, simulated sensor data can be used for generating the numerical model.

Lastly, the numerical model is stored by the control device, especially in the data storage device of the control device or the like, for configuring the thermal energy storage system. By these means, the thermal energy storage system is configured for operation.

For machine learning, a supervised machine learning method, e.g. based on neural networks is used. The neural networks consist of several—between 2 and 10—fully connected hidden layers. The number of nodes in the hidden layers is between 10 and 50 in each layer. The neural networks are trained by utilizing at least a portion of either measured physical sensor data, e.g. temperature, pressure, force, flow, displacement and/or humidity, or simulated data from CFD, FEM or DEM, or a combination of physical sensor and simulated data to predict results for other locations. The models are implemented utilizing the open source machine learning platform Tensorflow with a Keras interface. The neural networks are tested for accuracy on an independent data set.

The method for configuring a thermal energy storage system has the advantage over conventional art solutions that by simple and cost effective means, the thermal energy storage system can be configured. Thus, the amount of necessary sensors for the production of the thermal energy storage system can be reduced due to the provision of virtual temperature sensors by the numerical model. By these means, costs for production of the thermal energy storage system can be reduced. Moreover, in case of a broken temperature sensor, the broken temperature sensor can be easily replaced by a corresponding virtual temperature sensor by means of the numerical model. This further helps to increase reliability of the thermal energy storage system and to reduce maintenance costs, since broken sensors do not necessarily have to be replaced anymore.

It is desired that the numerical model is generated based on a temperature distribution of a heat transfer fluid of the thermal energy storage device. As heat transfer fluid, air is used. The temperature distribution of the heat transfer fluid is determined by the plurality of temperature sensors. This has the advantage that at low cost and with reduced required complexity, the numerical model is configured for determining the temperature of the heat transfer fluid at a specific volume point, at a group of volume points and more desirably at all volume points, of the thermal energy storage device.

Advantageously, the numerical model is generated based on a pressure and/or mass flow distribution of a heat transfer fluid of the thermal energy storage device. The pressure and/or mass flow distribution of the heat transfer fluid is determined by the plurality of pressure sensors. This has the advantage that at low cost and with reduced required complexity, the numerical model is configured for determining the pressure and/or mass flow of the heat transfer fluid at a specific volume point, at a group of volume points and more desirably at all volume points, of the thermal energy storage device.

The numerical model is generated for multiple temperature sensors of the plurality of temperature sensors. By these means, the numerical model is configured for providing multiple virtual temperature sensors, for the majority of temperature sensors. Further, the numerical model is generated for the whole plurality of temperature sensors. This has the advantage, that the amount of temperature sensors for enabling an efficient operation of the thermal energy storage system can be reduced significantly. Thus, a thermal energy storage system can be equipped with less temperature sensors, wherein the cancelled temperature sensors can be replaced by virtual temperature sensors by means of the numerical model. Moreover, failure of a temperature sensor of the thermal energy storage system can be compensated easily by virtually replacing the broken temperature sensor with a virtual temperature sensor by means of the numerical model. This can save production and maintenance costs of the thermal energy storage system. Beyond that, shutdown times of the thermal energy storage system due to replacement of broken temperature sensors can be avoided.

For generating the numerical model, a computational fluid dynamic model and/or a finite element method model and/or a discrete element method model of the thermal energy storage device for representing temperatures of a plurality of volume elements of the thermal energy storage device is used, wherein the numerical model is based on properties of the thermal energy storage device. With a numerical model, based on a computational fluid dynamic model, a finite element method model or a discrete element method model of the thermal energy storage device and actual sensor data of at least a part of the plurality of temperature sensors, temperatures and temperature developments of volume elements, of each volume element, of the thermal energy storage device can be determined reliably. The finite element method model and discrete element method model are used in combination with pressure sensors or force sensors. This especially concerns volume elements that are not controlled by a non-virtual temperature sensor. The generation of a computational fluid dynamic model, a finite element method model or a discrete element method model has the advantage, that a reliable and robust analysis of the operational status of the thermal energy storage system can be generated in real time and in a cost-efficient way.

According to a second aspect of embodiments of the invention, the problem is solved by a thermal energy storage system, especially an electro thermal energy storage system, comprising a thermal energy storage device for storing heat, a plurality of temperature sensors, distributed at different locations of the thermal energy storage device for measuring temperatures at the different locations, and a control device for reading measurement data of the plurality of temperature sensors. According to embodiments of the invention, a numerical model for at least one first temperature sensor of the plurality of temperature sensors based on measured temperatures of the plurality of temperature sensors by means of machine learning is stored in the control device, wherein the control device is configured for predicting a temperature at the at least one first temperature sensor by means of temperatures of at least a group of the plurality of temperature sensors and the numerical model.

In other words, the numerical model is stored in the control device. The control device can be located at the thermal energy storage device or at a remote location. The control device is configured for reading measurement data of the plurality of temperature sensors. The control device is configured for reading measurement data of other sensors, such as pressure sensors or flow sensors of the thermal energy storage device, as well. Moreover, the control device is configured for using the measurement data of the plurality of temperature sensors or at least of a group of the plurality of temperature sensors—and other sensors—in combination with the numerical model to determine physical parameter data of at least one location within the volume of the thermal energy storage device. Thus, at least one virtual temperature sensor is provided. The control device is configured to provide such virtual temperature sensor at a location of a real temperature sensor of the plurality of temperature sensors. Alternatively or additionally, the control device is configured to provide such virtual temperature sensor at a location of the thermal energy storage device where no temperature sensor is present.

The thermal energy storage system has the same advantages over conventional art solutions as already discussed with respect to the method for configuring an thermal energy storage system according to the first aspect of embodiments of the invention. Therefore, the thermal energy storage system according to embodiments of the invention has the advantage over known thermal energy storage systems that the amount of necessary sensors for the production of the thermal energy storage system can be reduced due to the provision of virtual temperature sensors by the numerical model. By these means, costs for production of the thermal energy storage system can be reduced as well. Moreover, in case of a broken temperature sensor, the broken temperature sensor can be easily replaced by a corresponding virtual temperature sensor by means of the numerical model. This further helps to increase reliability of the thermal energy storage system and to reduce maintenance costs, since broken temperature sensors do not necessarily have to be replaced anymore.

Further, the thermal energy storage system is configured by the method according to the first aspect of embodiments of the invention. This has the advantage that the thermal energy storage system is configured by simple and cost effective means.

With the temperature sensors provided, a state of charge of the thermal energy storage device can be reliably determined. Additionally, the thermal energy storage system further comprises a plurality of sensors that are configured as pressure sensors and/or flow sensors, in order to determine fluid mechanical properties of the heat transfer fluid, such as current speed or the like. The temperature sensors and/or the pressure sensors and/or flow sensors are evenly distributed over the volume of the thermal energy storage device. This has the advantage that a status of the thermal energy storage system can be determined reliably and in a cost efficient way.

According to a third aspect of embodiments of the invention, the problem is solved by a method for operating a thermal energy storage system, especially an electro thermal energy storage system, according to the second aspect of embodiments of the invention. The method comprising the following steps:
measuring or simulating temperature at the different locations by a plurality of temperature sensors,
processing the measured temperatures with a numerical model by the control device of the thermal energy storage system, and
determining a temperature of a location of a first virtual temperature sensor of the thermal energy storage system, based on the numerical model and the temperatures.

The temperatures are measured by the plurality of temperature sensors. This means that the temperatures can be measured by at least one temperature sensor or at least a group of temperature sensors of the plurality of temperature sensors. The temperature sensors for providing the temperature values are selected such that there is enough sensor information for reliably using the numerical model for generating virtual physical data for virtual temperature sensors.

The temperatures are processed by the control device with the numerical model. By these means, virtual temperature sensor data of at least one virtual temperature sensor of the thermal energy storage system is determined. The virtual temperature sensor can be at a location of the thermal energy storage device where a broken temperature sensor is located. Alternatively, the virtual temperature sensor can be at a location of the thermal energy storage device where no temperature sensor is located. In a further alternative, the virtual temperature sensor can be at a location of the thermal energy storage device where a normal working temperature sensor is located in order to test the accuracy of that sensor or in order to improve the quality of the numerical model by means of machine learning.

The method for operating an inventive thermal energy storage system has the same advantages over conventional art solutions as already discussed with respect to the method for configuring a thermal energy storage system according to the first aspect of embodiments of the invention and the thermal energy storage system according to the second aspect of embodiments of the invention. Therefore, the inventive method has the advantage over known methods that the amount of necessary sensors for the production of the thermal energy storage system can be reduced due to the provision of virtual temperature sensors by the numerical model. By these means, costs for production of the thermal energy storage system can be reduced as well. Moreover, in case of a broken temperature sensor, the broken temperature sensor can be easily replaced by a corresponding virtual temperature sensor by means of the numerical model. This further helps to increase reliability of the thermal energy storage system and to reduce maintenance costs, since broken temperature sensors do not necessarily have to be replaced anymore.

### BRIEF DESCRIPTION

Some of the embodiments will be described in detail, with reference to the following figures, wherein like designations denote like members, wherein:

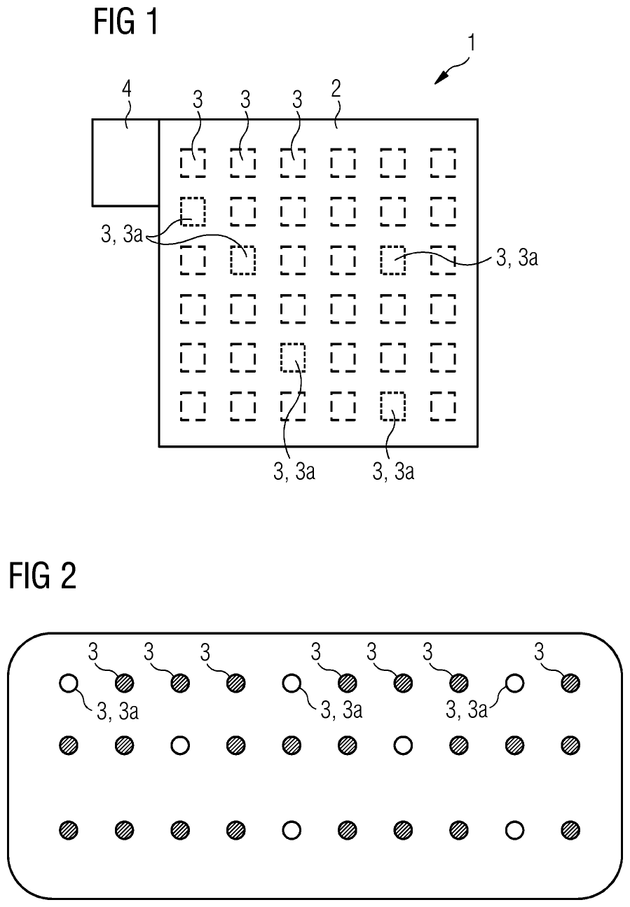

FIG. 1 shows a schematic side view of an embodiment of a thermal energy storage system according to the second aspect of the invention;

FIG. 2 shows a schematic view of a sensor configuration according to an embodiment of the invention;

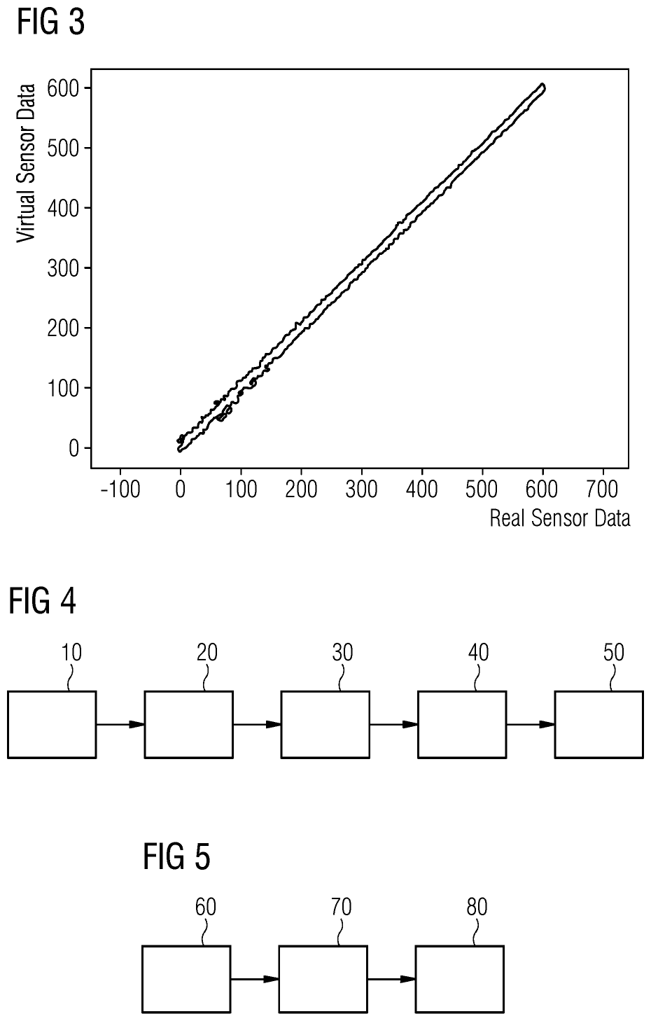

FIG. 3 shows a diagram illustrating the accuracy of virtual sensors in comparison with regular sensors;

FIG. 4 shows a flow chart of the inventive method according to the first aspect of the invention; and

FIG. 5 shows a flow chart of the inventive method according to the third aspect of the invention.

### DETAILED DESCRIPTION

Elements with the same function and effectiveness are denoted each in FIGS. 1 to 5 with the same reference numbers.

In FIG. 1, an embodiment of a thermal energy storage system 1 according to the second aspect of embodiments of the invention is shown in a schematic side view. The thermal energy storage system 1 is configured as an electro thermal energy storage system 1. The thermal energy storage system 1 comprises a thermal energy storage device 2 for storing heat. Within the thermal energy storage device 2, a plurality of temperature sensors 3 is shown. Moreover, one or more not illustrated other sensors, such as pressure sensors, can be provided. A few temperature sensors 3 are configured as virtual temperature sensors 3a by means of the numerical model. The numerical model is stored in a control device 4 of the thermal energy storage system 1 for reading measurement data of the plurality of temperature sensors 3.

In FIG. 2, a temperature sensor 3 configuration according to embodiments of the invention is shown in a schematic view. The temperature sensors 3 shown as filled circles are used as input data for generating the numerical model by machine learning. The temperature sensors 3 shown as open circles are virtual temperature sensors 3a, generated by the numerical model.

In FIG. 3, a diagram illustrating the accuracy of virtual temperature sensors 3a in comparison with regular temperature sensors 3 is shown. As can be inferred from this diagram, the real temperature sensor 3 data and the virtual temperature sensor 3a data show a clear correlation. This means that, by means of the numerical model, virtual temperature sensors 3a with high accuracy can be provided.

In FIG. 4, a flow chart of the inventive method according to the first aspect of embodiments of the invention is shown. In a first step 10, a thermal energy storage device 2 for storing heat is provided. In a second step 20, a plurality of temperature sensors 3 is provided at different locations of the thermal energy storage device 2 for measuring temperatures at the different locations. In a third step 30, a control device 4 of the thermal energy storage system 1 for reading measurement data of the plurality of temperature sensors 3 is provided. In a fourth step 40, a numerical model for at least one first temperature sensor 3 of the plurality of temperature sensors 3 is generated based on the measured physical parameters of the plurality of temperature sensors 3 by means of machine learning. In a fifth step 50, the numerical model is stored in the control device 4 for configuring the thermal energy storage system 1. Now, the thermal energy storage system 1 is configured to compensate a broken temperature sensor 3 with a virtual temperature sensor 3a by means of the numerical model.

In FIG. 5, a flow chart of the inventive method according to the third aspect of embodiments of the invention is shown. Since the inventive method according to the third aspect of embodiments of the invention is based on the inventive method according to the first aspect of embodiments of the invention, the numbering of the method steps is continued. In a sixth step 60, physical parameters are measured at the different locations by a plurality of temperature sensors 3 of the thermal energy storage system 1. In a seventh step 70, the measured physical parameters are processed with the numerical model by the control device 4 of the thermal energy storage system 1. In an eighth step 80, a physical parameter of a location of a first virtual temperature sensor 3a of the thermal energy storage system 1 is determined by the control device 4, based on the numerical model and the measured physical parameters. In other words, by these means, physical values at different locations within the thermal energy storage device 2 can be determined without the need of generating real measurement data at these locations.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for configuring a thermal energy storage system, comprising the following steps:
providing a thermal energy storage device for storing heat,
providing a plurality of temperature sensors at different locations of the thermal energy storage device for measuring temperatures at the different locations,
providing a control device of the thermal energy storage system for reading measurement data of the plurality of temperature sensors,
generating a numerical model for at least one first temperature sensor of the plurality of temperature sensors based on measured and/or simulated temperature values of the plurality of temperature sensors by means of machine learning, and
storing the numerical model by control device of the thermal energy storage, for configuring the thermal energy storage system.

2. The method according to claim 1, wherein
the numerical model is generated on the basis of a temperature distribution of a heat transfer fluid of the thermal energy storage device.

3. The method according to claim 1, wherein
the numerical model is generated on the basis of a pressure and/or mass flow distribution of a heat transfer fluid of the thermal energy storage device.

4. The method according to claim 1, wherein
the numerical model is generated for multiple temperature sensors of the plurality of temperature sensors.

5. The method according to claim 1, wherein
for generating the numerical model, a computational fluid dynamic model and/or a finite element method model and/or a discrete element method model of the thermal energy storage device for representing temperatures of a plurality of volume elements of the thermal energy storage device is used, wherein the numerical model is based on properties of the thermal energy storage device.

6. A thermal energy storage system, comprising a thermal energy storage device for storing heat, a plurality of temperature sensors, distributed at different locations of the thermal energy storage device for measuring physical parameters at the different locations, and a control device for reading measurement data of the plurality of temperature sensors,
wherein
a numerical model for at least one first temperature sensor the plurality of temperature sensors based on measured physical parameters of the plurality of temperature sensors by means of machine learning is stored in the control device, wherein the control device is configured for predicting a physical parameter at the at least one first temperature sensor by means of physical parameters of at least a group of the plurality of temperature sensors and the numerical model.

7. The thermal energy storage system disaccording to claim 6, wherein
the thermal energy storage system is configured by the method of:
providing a thermal energy storage device for storing heat,
providing a plurality of temperature sensors at different locations of the thermal energy storage device for measuring temperatures at the different locations,
providing a control device of the thermal energy storage system for reading measurement data of the plurality of temperature sensors,
generating a numerical model for at least one first temperature sensor of the plurality of temperature sensors based on measured and/or simulated temperature values of the plurality of temperature sensors by means of machine learning, and
storing the numerical model by a control device of the thermal energy storage, for configuring the thermal energy storage system.

8. A method for operating the thermal energy storage system according to claim 6, comprising the following steps:
measuring temperatures at the different locations by a plurality of temperature sensors,
processing the measured temperatures with a numerical model by the control device of the thermal energy storage system, and
determining a temperature of a location of a first virtual temperature sensor of the thermal energy storage system, based on the numerical model and the measured temperatures.
